(19) United States
(12) Patent Application Publication
(10) Pub. No.: US 2025/0150487 A1
(43) Pub. Date: May 8, 2025

(54) CONTROL DEVICE, DETECTION SYSTEM, CONTROL METHOD, AND RECORDING MEDIUM

(71) Applicant: NEC Corporation, Tokyo (JP)

(72) Inventors: Shota KIZUKURI, Tokyo (JP); Takahisa Yutoku, Tokyo (JP); Wataru Takahashi, Tokyo (JP); Yusuke Matsui, Tokyo (JP); Yoshihiko Koizumi, Tokyo (JP)

(21) Appl. No.: 18/822,742

(22) Filed: Sep. 3, 2024

(30) Foreign Application Priority Data
Nov. 2, 2023 (JP) 2023-188566

(51) Int. Cl. H04L 9/40; G06F 40/177; G06T 11/60

(52) U.S. Cl. CPC H04L 63/1483; G06F 40/177; G06T 11/60

(57) ABSTRACT

Provided is a control device including a display information generation unit that generates display information including first information regarding each of at least one fake site that falsifies a management target site and second information in which a status regarding take-down of each of the at least one fake site is aggregated, and a display control unit that performs control to display the generated display information on a screen.

This application is based upon and claims the benefit of priority from Japanese Patent Application No. 2023-188566, filed on Nov. 2, 2023, the disclosure of which is incorporated herein in its entirety by reference.

### TECHNICAL FIELD

The present disclosure relates to a control device, a detection system, a control method, and a recording medium.

### BACKGROUND ART

A damage of a web site (fake site) in which information displayed on a company's home page (corporate site) is copied is increasing. Fake sites lead to abuse of phishing sites and a reduction in group reputation. Therefore, it is required to accurately detect a fake site.

PTL 1 (JP 2015-187779 A) discloses an information processing system including a fake site detection device. The fake site detection device of PTL 1 detects a fake site using scenario information registered in advance. For example, as an approach for detecting a fake site, there are techniques such as web crawling and domain name system (DNS) record monitoring.

By using a method such as PTL 1, web crawling, and DNS record monitoring, it is possible to detect a fake site in operation. However, even if a fake site can be detected by these methods, it is difficult to ensure computer security for a company.

An object of the present disclosure is to provide a control device, a detection system, a control method, and a program capable of grasping computer security of a fake site or the like.

### SUMMARY

A control device according to an aspect of the present disclosure includes a display information generation unit that generates display information including first information regarding each of at least one fake site that falsifies a management target site and second information in which a status regarding take-down of each of the at least one fake site is aggregated, and a display control unit that performs control to display the generated display information on a screen.

In a control method according to an aspect of the present disclosure, the method includes generating display information including first information regarding each of at least one fake site that falsifies a management target site and second information in which a status regarding take-down of each of the at least one fake site is aggregated, and performing control to display the generated display information on a screen.

A program according to an aspect of the present disclosure causes a computer to execute generating display information including first information regarding each of at least one fake site that falsifies a management target site and second information in which a status regarding take-down of each of the at least one fake site is aggregated, and performing control to display the generated display information on a screen.

### BRIEF DESCRIPTION OF THE DRAWINGS

Exemplary features and advantages of the present invention will become apparent from the following detailed description when taken with the accompanying drawings in which:

FIG. 1 is a conceptual diagram for explaining an example of a configuration of a detection system according to the present disclosure;

FIG. 2 is a conceptual diagram illustrating an example of a site image displayed on a management target site according to the present disclosure;

FIG. 3 is a conceptual diagram illustrating an example of a source code of a site image displayed on the management target site according to the present disclosure;

FIG. 4 is a conceptual diagram for explaining a detection example of a fake site by the detection system according to the present disclosure;

FIG. 5 is a conceptual diagram illustrating an example of a configuration of a detection device included in the detection system according to the present disclosure;

FIG. 6 is a table illustrating an example of a whitelist used by the detection device included in the detection system according to the present disclosure;

FIG. 7 is a table illustrating an example of a blacklist used by the detection device included in the detection system according to the present disclosure;

FIG. 8 is a conceptual diagram illustrating an example of a configuration of a control device included in the detection system according to the present disclosure;

FIG. 9 is a conceptual diagram illustrating an example of a template of display information generated by the control device included in the detection system according to the present disclosure;

FIG. 10 is a conceptual diagram illustrating an example of display information generated by the control device included in the detection system according to the present disclosure;

FIG. 11 is a conceptual diagram illustrating an example of display information generated by the control device included in the detection system according to the present disclosure;

FIG. 12 is a flowchart for explaining an example of the operation of the detection device included in the detection system according to the present disclosure;

FIG. 13 is a flowchart for explaining an example of fake site detection processing by the detection device included in the detection system according to the present disclosure;

FIG. 14 is a flowchart for explaining an example of the operation of the control device included in the detection system according to the present disclosure;

FIG. 15 is a block diagram illustrating an example of a configuration of a control device according to the present disclosure;

FIG. 16 is a flowchart for explaining an example of the operation of the control device according to the present disclosure; and

FIG. 17 is a block diagram illustrating an example of a hardware configuration that executes control and processing according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a configuration of a detection system according to a first example embodiment will be described with reference to the drawings. The detection system according to the present example embodiment detects a web site (fake site) in which information displayed on a company's home page (corporate site) is copied. Fake sites may be used for phishing. The detection system according to the present example embodiment presents, to an administrator of a corporate site (management target site) to be managed, display information that enables accurate grasping of information regarding a fake site.

Hereinafter, an example of detecting a fake site of a management target site by using an access to a source code of an image displayed on the management target site as a trigger will be described. The method according to the present example embodiment can be applied to an application of detecting a fake site of a management target site using not only an image but also a copy of information (content) such as a sentence, a moving image, and a voice as a trigger. The method according to the present example embodiment can be applied not only to detection of a corporate site but also to detection of a fake site to which information (content) of an arbitrary web site is copied. The method according to the present example embodiment may be, for example, a method of detecting an access in which a fake site acquires content of a management target site in a case where the fake site is opened. The method according to the present example embodiment may be, for example, a method of detecting access to content of a management target site caused by an operation performed on a fake site.

### (Configuration)

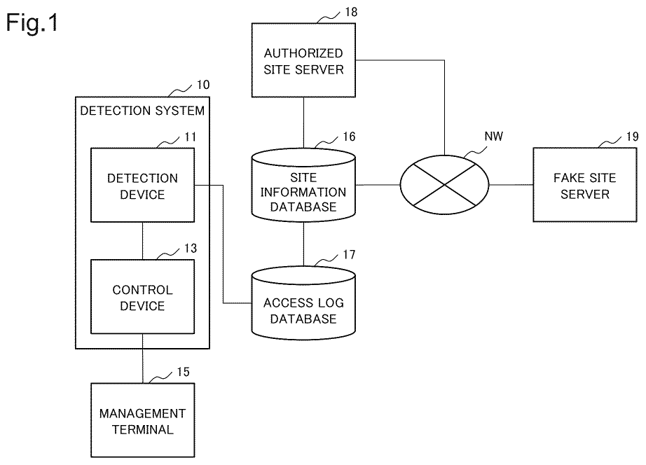

FIG. 1 is a block diagram for explaining an example of a configuration of a detection system according to the present disclosure. A detection system 10 includes a detection device 11 and a control device 13. FIG. 1 illustrates an authorized site server 18 and a fake site server 19. The authorized site server 18 is a server used for operating the management target site. The fake site server 19 is a server used by an operator who intends to open a fake site of a management target site. Hereinafter, the unauthorized link of the management target site is prohibited.

The authorized site server 18 generates information displayed on the management target site according to the setting by the administrator of the management target server. Hereinafter, an image (site image) is assumed as information displayed on the management target site. The site image may include information such as characters and symbols. The authorized site server 18 is connected to a network NW such as the Internet. The site image generated using the authorized site server 18 can be displayed on a screen of a terminal device connected to the network NW. The authorized site server 18 is connected to a site information database 16. The authorized site server 18 stores information (including a site image) regarding the management target site in the site information database 16.

The site information database 16 is connected to the authorized site server 18 and an access log database 17. The site information database 16 is connected to the network NW such as the Internet. The site information database 16 can be accessed via the network NW. The site information database 16 stores information regarding the management target site. The information stored in the site information database 16 includes a file of a site image (site image file). The site image file is a file of a site image displayed on the management target site.

For example, the image format of the site image file is portable network graphics (PNG). The image format of the site image file is not limited to PNG as long as the image can be displayed on a web site. For example, the image format of the site image file may be the joint photographic experts group (JPEG) or the graphics interchange format (GIF). For example, the image format of the site image file may be WebP or scalable vector graphics (SVG).

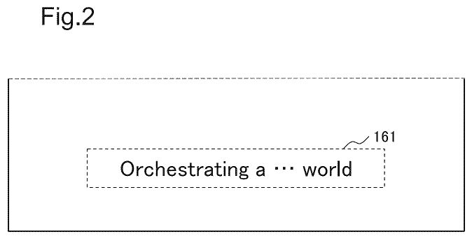

FIG. 2 is a conceptual diagram illustrating an example of a site image displayed on a management target site. FIG. 2 illustrates an example in which a part of the site image displayed on the management target site is displayed. FIG. 2 illustrates display information (site image 161) including textual information of “Orchestrating . . . world” as an example of the site image of the management target site.

The site image file is described by an absolute path in an image tag (img tag) in a source code of the management target site. That is, the site image file is described not by a relative path but by an absolute path. Unauthorized links of the management target site are prohibited. Therefore, the site image displayed on the management target site does not include an image that functions as a hyperlink displayed without permission of the administrator.

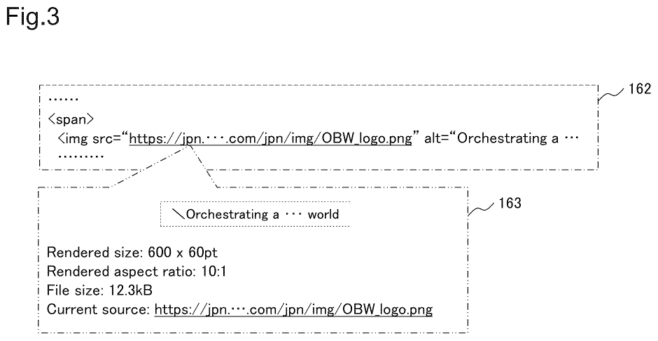

FIG. 3 is a conceptual diagram for explaining an example of an absolute path of a site image displayed on a management target site. A source code 162 includes an absolute path that is a reference destination of the site image 161 (FIG. 2). A source code 163 includes information regarding the site image 161. For example, the source code 163 includes information regarding the size of the rendered site image 161, the aspect ratio of the rendered site image 161, the file size of the site image 161, and the link destination of the site image 161. The detection device may have a function of setting a path indicating a site image in the source code 162 as an absolute path, or may have a function of updating a relative path to an absolute path in a case where the path is described as a relative path.

When an access to the fake site to which the source code of the display portion of the site image displayed on the management target site is copied is detected, the site image file is read from the site information database 16 via the absolute path of the site image. When the site image file is read, an access log indicating an access status to the site information database 16 is stored in the access log database 17. That is, according to the access to the site image file stored in the site information database 16, the domain information of the access source is recorded in the access log database 17 as a referrer (reference source). For example, the access log includes domain information regarding the domain of the device to which the site image is copied. For example, the access log includes an access detection date, an access source domain, a domain registrant, an Internet Protocol (IP) location, and an IP address. By using the access log recorded in the access log database 17, the fake site can be detected almost simultaneously with the start-up of the fake site.

The fake site server 19 is one of servers connected to the network NW. The fake site server 19 is used by an operator who intends to operate a fake site. The fake site server 19 is connected to the site information database 16 via the network NW. The fake site server 19 can access the site image stored in the site information database 16 via the management target site. When an access to the source code of the site image displayed on the management target site is detected, an access log including domain information of the fake site server 19 is stored in the access log database 17.

The detection device 11 is connected to the access log database 17. The detection device 11 detects access to the source code of the site image displayed on the management target site using the access log stored in the access log database 17. The site image file displayed on the management target site is not link-free. Therefore, the detection device 11 can detect the access to the source code of the site image according to the access to the access log database 17. The detection device 11 retrieves the access log stored in the access log database 17 at a timing set in advance by the administrator of the management target site. The detection device 11 detects access to the source code of the site image using the retrieved access log at a timing set in advance by the administrator of the management target site.

The detection timing of the access to the source code of the site image is set by the administrator of the management target site. For example, the detection timing of the access to the source code of the site image is set to a specific time set in advance. For example, the specific time is set to midnight or early morning when access to the management target site is small. In a time zone in which access is small, a delay in acquisition of the access log is less likely to occur. For example, the specific time may be set during the day when there are many accesses to the management target site. In a time zone with many accesses, access to the source code of the site image can be detected in real time.

The detection device 11 refers to a whitelist in which domain information permitting access to a site image is recorded, and verifies whether the domain information recorded as a referrer in the access log database 17 is an authorized domain. In a case where the domain information recorded as a referrer is recorded in the whitelist, the detection device 11 determines that the access from the fake site server 19 established in the domain is normal. In a case where the domain information recorded as a referrer is not recorded in the whitelist, the detection device 11 determines that the access from the fake site server 19 established in the domain is illegal. When detecting illegal access, the detection device 11 generates detection information including domain information of a domain of an access source. The detection information includes display information regarding a fake site falsified as a management target site. The detection information is information for each fake site. The detection device 11 outputs the generated detection information to the control device 13.

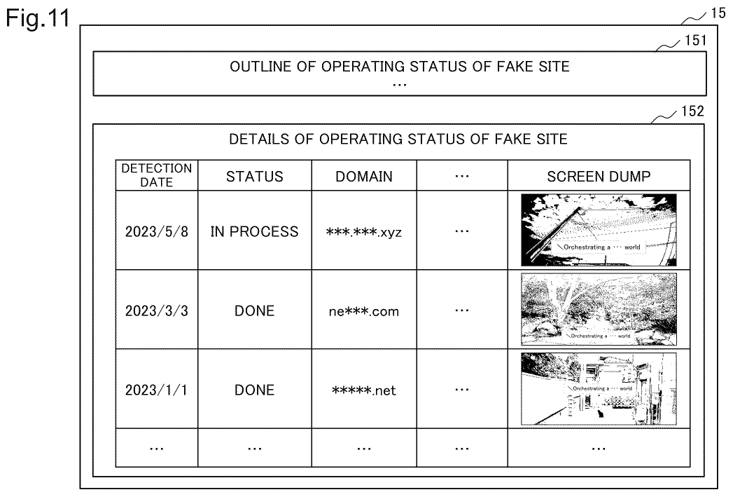

The detection information includes details of the operating status of the fake site. For example, the details of the operating status of the fake site include a detection date, a domain, a domain registrant, and an IP location of a fake site. For example, the details of the operating status of the fake site may include an IP address. For example, the detection information may include a site image copied to a fake site. The detection information may include a source code such as hyper text markup language (html) describing a fake site. The source code does not necessarily need to be html, and may be any language that can describe a homepage. The detection information may include a screen dump in which an image displayed on the fake site is captured. The screen dump can prevent access to a fake site, for example, when displaying an outline as illustrated in FIG. 11 described later. If information such as a detection date, a status, a domain, a domain registrant, and an IP location of a fake site is displayed side by side, an administrator can intuitively grasp details of an operating status regarding each fake site. For example, when information such as a detection date, a status, a domain, a domain registrant, and an IP location of a fake site is displayed on a screen in a format of being aggregated on one screen, an administrator can more intuitively grasp details of an operating status regarding each fake site. A format in which information such as a detection date, a status, a domain, a domain registrant, and an IP location of a fake site is aggregated on one screen is also referred to as a dashboard format.

Taking down the detected fake site is entrusted to, for example, an external agency. take-down in the present disclosure is to make it impossible to refer to a fake site via the network NW, such as deleting content that may damage a company image or a fake site including malicious content. Taking down the detected fake site is entrusted to, for example, a contract organization such as a security professional organization, a hosting company, or a domain registrar. When taking down the fake site in a stage before the request, the status of the take-down is expressed as before the take-down or unprocessed. When taking down the fake site in a requesting stage, the status of the take-down is expressed as being taken down or being processed. When the take-down of the fake site by the contract organization is completed, the status of the take-down is expressed as taken down or processed. The expression of the status of the take-down is not limited to the above example. The status of the take-down of the fake site is used for generation of display information by the control device 13.

The status includes an outline of an operating status of the detected fake site. For example, the outline of the operating status of the fake site includes the number of fake sites that are in operation, the number of fake sites that are in take-down, and the number of fake sites that have been taken down. If the number of fake sites in operation, the number of fake sites in take-down, and the number of fake sites that have been taken down are displayed on the screen in a dashboard format, the administrator can intuitively grasp the overview of the operating status of the fake sites.

A management terminal 15 is a terminal device used by the administrator of the management target site. The management target site is a web site on which company information is posted. The administrator manages the management target site using the management terminal 15. For example, the administrator of the management target site is an employee of a company that operates the management target site. The administrator of the management target site is not limited to an employee of a company that operates the management target site. For example, the administrator of the management target site may be a contractor who is entrusted with creation and management of the management target site. The management terminal 15 is connected to the control device 13. The administrator inputs the status of the take-down of the fake site to the control device 13 using the management terminal 15.

The control device 13 is connected to the management terminal 15. The control device 13 acquires the detection information generated by the detection device 11. The control device 13 acquires the status of the take-down of the fake site input using the management terminal 15. The control device 13 generates display information including the operating status of the fake site using the acquired detection information and status. The control device 13 displays the generated display information on the screen of the management terminal 15. The administrator who has browsed the display information displayed on the screen of the management terminal 15 can accurately grasp the operating status of the fake site. For example, the control device 13 may output the generated display information to an external system. The use of the display information output to the external system is not particularly limited. For example, by using the display information output to the external system, the operating status of the fake site can be confirmed remotely.

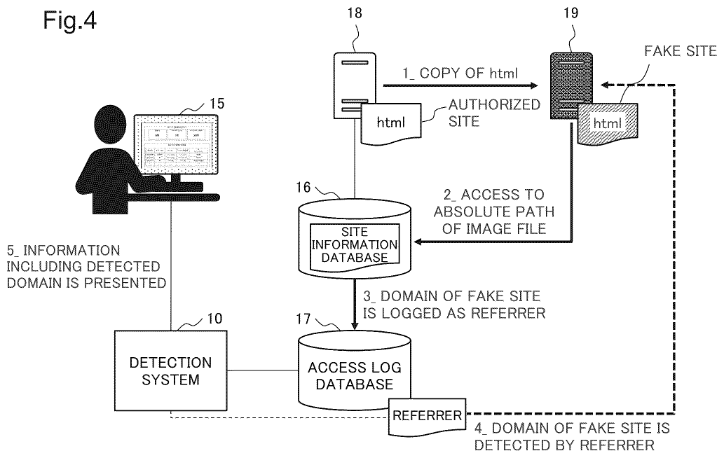

FIG. 4 is a conceptual diagram for explaining a flow of fake site detection by the detection system according to the present disclosure. FIG. 4 illustrates an example in which establishment of a fake site of a management target site (authorized site) disclosed via the authorized site server 18 is detected. FIG. 4 is an example, and does not limit the flow of fake site detection according to the present disclosure.

In FIG. 4, first, the fake site server 19 copies html (site image file) of an authorized site. When a fake site starts up in the fake site server 19, access to an absolute path (full path) of an authorized site occurs by html. Depending on the access to the absolute path of the site image file, the domain of the fake site is logged in the access log database 17 as a referrer. Since the authorized site can be determined that the access source is not the authorized site by referring to the referrer, the site that is the access source can be determined to be the fake site. The detection system 10 detects the domain of the fake site using the referrer logged in the access log database 17. The detection system 10 presents information including the detected domain to the management terminal 15. The information presented on the management terminal 15 is displayed on the screen of the management terminal 15. The administrator can detect the establishment of the fake site by referring to the information displayed on the screen of the management terminal 15. According to the method of the present example embodiment, it is possible to detect the establishment of a fake site at a stage where the fake site starts up. Therefore, according to the method of the present example embodiment, for example, the information regarding the fake site can be grasped at a stage before the fake site is fully operated. That is, according to the method of the present example embodiment, it is possible to grasp computer security of a fake site or the like.

As in the example of FIG. 4, the detection system 10 can detect access to a source code of a site image according to an action (copy) for an absolute path of the site image file. In the case of the dead copy via the absolute path, access from the fake site server 19, which is an external site, to the authorized site server, which is an authorized site, occurs. Therefore, the detection system 10 can detect the establishment of the fake site using the access to the absolute path as a trigger. In the case of an image file such as a site image, access to an absolute path can be logged without being noticed by an operator of a fake site. The method of the present example embodiment can also be applied to detection of a fake site other than the dead copy. For example, by using the method of the present example embodiment, it is possible to detect an arbitrary web page that uses a site image of a management target site (authorized site) without permission.

### [Detection Device]

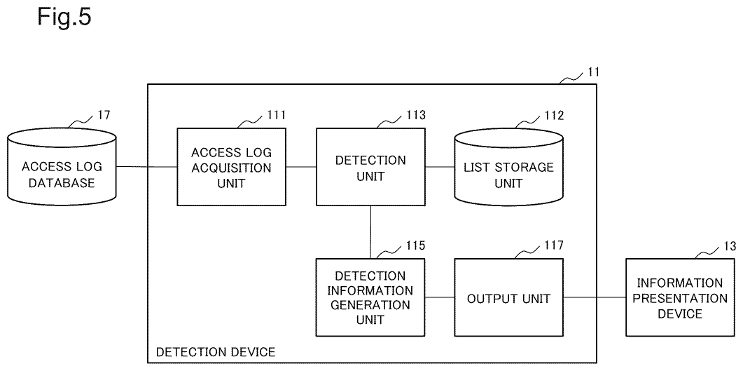

Next, the detection device 11 included in the detection system 10 of the present example embodiment will be described with reference to the drawings. FIG. 5 is a block diagram illustrating an example of a configuration of a detection device according to the present disclosure. The detection device 11 includes an access log acquisition unit 111, a list storage unit 112, a detection unit 113, a detection information generation unit 115, and an output unit 117.

The access log acquisition unit 111 is connected to the access log database 17. The access log acquisition unit 111 obtains the access log accumulated in the access log database 17. The access log includes domain information of an access source of the detected access. The domain information included in the access log is used to detect a fake site.

The list storage unit 112 stores a whitelist in which domain information permitting access to a site image of a management target site is registered. The domain registered in the whitelist is permitted to access the site image of the management target site. On the other hand, the domain not registered in the whitelist is not permitted to access the site image of the management target site. A domain that is not registered in the whitelist is a target detected as a fake site.

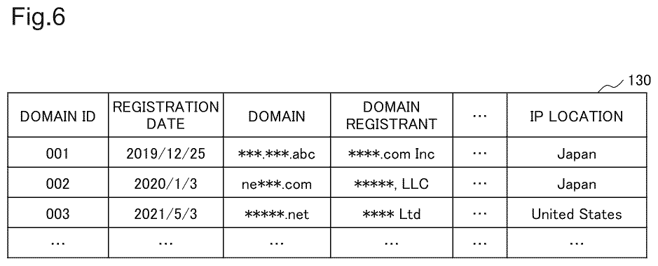

FIG. 6 is a table illustrating an example of the whitelist. In the whitelist 130, domain information including a domain identifier (ID), a registration date, a domain name, a domain registrant, . . . , and an IP location is registered for each domain. The whitelist 130 may include information other than a domain ID, a registration date, a domain name, a domain registrant, . . . , and an IP location. An IP address may be registered in the whitelist 130. The information registered in the whitelist 130 is updated according to an operation using the management terminal 15.

For example, a blacklist may be stored in the list storage unit 112. In this case, a domain registered in the blacklist is a target to be detected as a fake site. A domain that is not registered in the blacklist is permitted to access a site image if the domain is registered in the whitelist. For example, for a domain not registered in the blacklist, access to the source code of the site image may be permitted. For example, in response to detection of a new fake site, domain information of the fake site may be added to the blacklist.

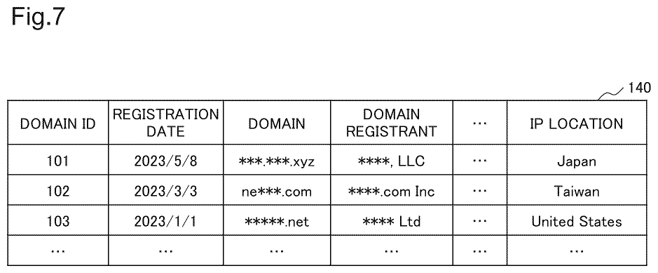

FIG. 7 is a table illustrating an example of the blacklist. In the blacklist 140, domain information including a domain identifier (ID), a registration date, a domain name, a domain registrant, . . . , and an IP location is registered for each domain. The blacklist 140 may include information other than a domain ID, a registration date, a domain name, a domain registrant, . . . , and an IP location. An IP address may be registered in the blacklist 140. The information registered in the blacklist 140 may be updated in response to detection of a new fake site.

The detection unit 113 extracts the domain of the access source from the domain information of the access log. The detection unit 113 refers to the whitelist stored in the list storage unit 112 and retrieves a domain matching the domain extracted from the domain information of the access log. In a case where there is no domain that matches the domain extracted from the domain information of the access log, the detection unit 113 detects the domain as a domain of a fake site. On the other hand, in a case where there is a domain that matches the domain extracted from the domain information of the access log, the detection unit 113 determines that the domain is a permitted domain. In this case, the detection unit 113 may output the determination result, or may not execute processing in particular. The detection unit 113 may exclude a domain included in the whitelist from the detection target. With such a configuration, it is possible to prevent excessive detection of the domain of the fake site.

The detection unit 113 may retrieve a domain matching the domain extracted from the domain information of the access log with reference to the blacklist stored in the list storage unit 112. In a case where there is a domain that matches the domain extracted from the domain information of the access log, the detection unit 113 detects the domain as a domain of a fake site. On the other hand, in a case where there is no domain that matches the domain extracted from the domain information of the access log, the detection unit 113 determines that the domain is a permitted domain. In this case, the detection unit 113 may output the determination result, or may not execute processing in particular. For example, the detection unit 113 may add domain information of a new fake site to the blacklist. If domain information of a new fake site is added to the blacklist, detection accuracy of the fake site using the blacklist is improved.

The detection information generation unit 115 generates detected information including domain information of the detected fake site. For example, the detection information includes information such as a detection date, a domain, a domain registrant, and an IP location of a detected fake site. The detection date is a date and time when the domain of the fake site is detected. The domain indicates the name of the domain of the fake site. The domain registrant indicates a registrant of the domain of the fake site. The IP location indicates a location where the fake site server 19 is located. For example, the IP location indicates a country or a region in which the fake site server 19 is arranged. The detection information may include an IP address.

Some fake sites are similar to authorized sites, and some are completely different from authorized sites. The fake site having an appearance completely different from that of the authorized site includes a site in which the body of the code is changed to an arbitrary code after the authorized site is dead-copied. There is also a case where a fake site that appears to be different content in appearance is constructed by superimposing another page on a page called an iframe after performing dead copy. The detection unit 113 detects a fake site according to access to a site image displayed on the management target site. Therefore, the detection unit 113 can also detect a fake site resembling the authorized site, and can also detect a fake site completely different from the authorized site. For example, since headers and footers are difficult to be processed by the operator of the fake site, they often remain even if they are dead-copied. Therefore, if the absolute path is included in the image of the header or the footer, there is a high possibility that fake site detection omission can be prevented even in a site completely different from the authorized site.

The output unit 117 is connected to the control device 13. The output unit 117 outputs detection information regarding the fake site to the control device 13. The detection information output to the control device 13 is processed by the control device 13 into image information in a display format that makes it easy to accurately grasp information regarding a fake site. The processed display information is displayed on the screen of the management terminal 15. The administrator who has browsed the display information displayed on the screen of the management terminal 15 can clearly grasp the information regarding the fake site.

The administrator may be notified in response to the detection of the fake site. For example, in response to the detection of a fake site, a notification in a format such as an electronic mail or an instant message is transmitted to the management terminal 15. The notification notifying the detection of a fake site may be displayed on the screen of the management terminal 15. The notification notifying of the detection of a fake site may be issued by voice from the speaker of the management terminal 15. For example, the notification indicating the detection of a fake site may be transmitted to a mobile terminal (not illustrated) carried by the administrator. The administrator who has received the notification in response to the detection of a fake site can detect the operation of the fake site earlier than browsing the display information displayed on the screen of the management terminal 15.

The output unit 117 may transmit detection information regarding the fake site to an external agency. In this case, the output unit 117 is connected to a system or a device of an external agency via the Internet. For example, the external agency is a contract organization for take-down of a fake site. The contractor organization for take-down is an organization such as a security professional organization, a hosting company, or a domain registrar. When taking down the fake site in a stage before the contract organization is requested, the status of the take-down is expressed as before the take-down or unprocessed. When taking down the fake site in the stage of being requested to the contract organization, the status of the take-down is expressed as being taken down or being processed. When the take-down of the fake site by the contract organization is completed, the status of the take-down is expressed as taken down or processed. The status of the take-down is not limited to the above expression as long as the status of the take-down of the fake site by the contract organization can be determined.

### [Control Device]

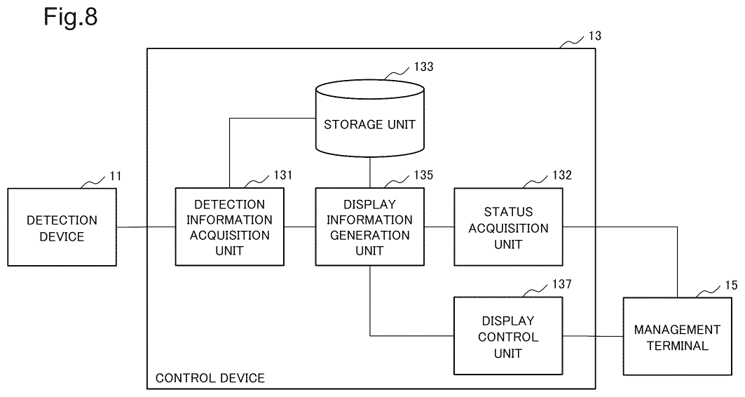

Next, the control device 13 included in the detection system 10 of the present example embodiment will be described with reference to the drawings. FIG. 8 is a block diagram illustrating an example of a configuration of a control device according to the present disclosure. The control device 13 includes a detection information acquisition unit 131, a status acquisition unit 132, a storage unit 133, a display information generation unit 135, and a display control unit 137.

The detection information acquisition unit 131 is connected to the detection device 11. The detection information acquisition unit 131 acquires detection information from the detection device 11. The detection information includes information regarding the domain of the fake site. The acquisition timing of the detection information is arbitrarily set. For example, the detection information acquisition unit 131 acquires the detection information from the detection device 11 at a predetermined acquisition timing. For example, the detection information acquisition unit 131 may acquire the detection information from the detection device 11 according to an operation of the management terminal 15 by the administrator.

The status acquisition unit 132 is connected to the management terminal 15. The status acquisition unit 132 acquires a status of the take-down of the fake site. The status of the take-down is input via the management terminal 15. When taking down the fake site in a stage before the contract organization is requested, the status of the take-down is input as before the take-down or unprocessed. When taking down the fake site in the stage of being requested to the contract organization, the status of the take-down is input as being taken down or being processed. When the take-down of the fake site by the contract organization is completed, the status of the take-down is input as taken down or processed. The status of the take-down is not limited to the above expression as long as the response status of the take-down of the fake site by the contract organization can be determined. The status of the take-down may be input from an external agency. In this case, the status acquisition unit 132 acquires the status of the take-down via the network NW such as the Internet.

The storage unit 133 stores a template of display information to be presented to the administrator. The template of the display information is a template for displaying the take-down status of the fake site and the domain information of the fake site in a dashboard format. For example, the template of the display information includes an area in which an outline of the operating status of the fake site is set. For example, the template of the display information includes an area in which details of the operating status of the fake site is set. For example, the template of the display information includes a region in which an outline of the operating status of the fake site is set and a region in which details of the operating status of the fake site are set.

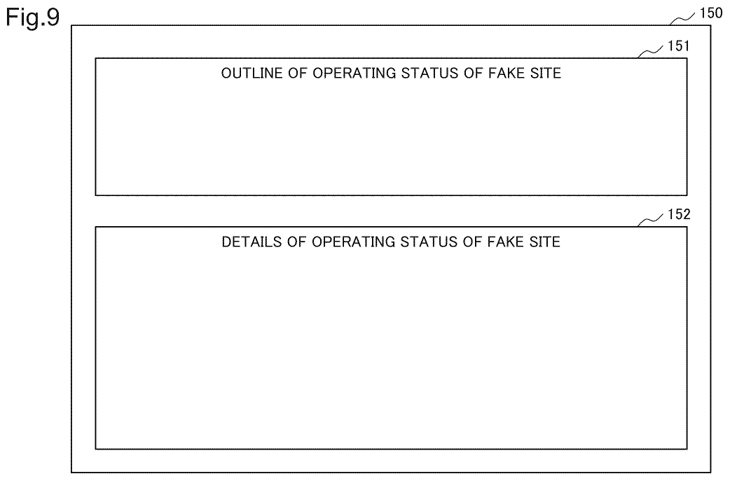

FIG. 9 is a conceptual diagram illustrating an example of a template of display information. A template 150 includes an outline region 151 and a detail region 152. In the outline region 151, an outline of the operating status of the fake site is set. Details of the operating status of the fake site are set in the detail region 152. The positional relationship between the outline region 151 and the detail region 152 is not limited. In the example of FIG. 9, the detail region 152 is set below the outline region 151. For example, the detail region 152 may be set above the outline region 151. For example, the outline region 151 and the detail region 152 may be set side by side. For example, the positional relationship between the outline region 151 and the detail region 152 may be set to be changeable according to an operation using the management terminal 15. The shapes of the outline region 151 and the detail region 152 are not limited to rectangles. For example, the shapes of the outline region 151 and the detail region 152 can be arbitrarily set to a trapezoid, a circle, an ellipse, or the like. The outline region 151 and the detail region 152 may be set in an optimized arrangement or shape for the administrator to grasp the operating status of the fake site. A region other than the outline region 151 and the detail region 152 may be set in the template 150. In a region other than the outline region 151 and the detail region 152, information relevant to the detection information may be set, or information not related to the detection information may be set. For example, information or a warning for notifying detection of a fake site may be set in a region other than the outline region 151 and the detail region 152.

The storage unit 133 stores detection information. Detection information of the detected fake site is accumulated in the storage unit 133. For example, the detection information stored in the storage unit 133 is erased according to the operation of the management terminal 15 by the administrator. The detection information stored in the storage unit 133 may be automatically erased at a preset timing.

The display information generation unit 135 acquires the detection information of the fake site from the detection information acquisition unit 131. The display information generation unit 135 acquires the status of the take-down of the fake site from the status acquisition unit 132. The display information generation unit 135 acquires a template of the display information from the storage unit 133. The template of the display information is a format for displaying a plurality of pieces of information included in the detection information and the status in a dashboard format in a display format optimized for grasping the risk of the fake site. The display information generation unit 135 generates display information in which the information included in the detection information and the information regarding the status of the take-down of the fake site are arranged in a dashboard format in the template of the display information. For example, the display information generation unit 135 sets, in the detail region 152, detailed information (also referred to as first information) including a detection date, a status, a domain, a domain registrant, an IP location of a fake site, and a screen dump of the fake site. The detailed information (first information) is information regarding each of at least one fake site that falsifies the management target site. For example, the display information generation unit 135 sets outline information (also referred to as second information) including the number of fake sites that are in operation, the number of fake sites that are in take-down, and the number of fake sites that have been taken down in the outline region 151. The outline information (second information) is information obtained by aggregating statuses regarding take-down of each of at least one fake site. The combination of the information set in the outline region 151 and the detail region 152 is not limited to the example described herein.

The display control unit 137 is connected to the management terminal 15. The display control unit 137 displays the display information generated by the display information generation unit 135 on the screen of the management terminal 15. On the screen of the management terminal 15, display information in which the status of the take-down of the fake site and the domain information are displayed in a dashboard format is displayed so that the administrator can easily grasp the operating status of the fake site. That is, on the screen of the management terminal 15, a plurality of pieces of information included in the detection information are displayed in association with each other in a display format optimized for grasping the risk of the fake site. For example, the display information may be output to an external system. In this case, the display control unit 137 outputs the display information to the external system via the network NW such as the Internet.

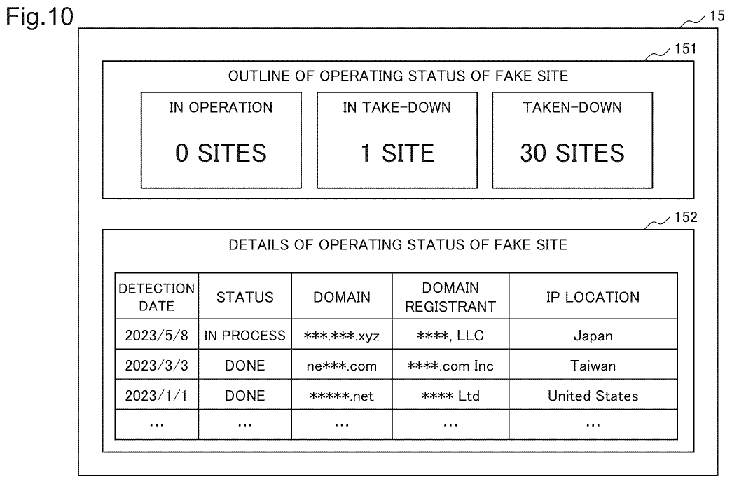

FIG. 10 is a conceptual diagram illustrating an example of the display information displayed on the screen of the management terminal. In the example of FIG. 10, on the screen of the management terminal 15, the detection information of the fake site and the information regarding the status of the take-down are displayed in the outline region 151 and the detail region 152.

In the example of FIG. 10, outline information including the number of fake sites that are in operation, the number of fake sites that are in take-down, and the number of fake sites that have been taken down is displayed in the outline region 151. According to the example of FIG. 10, it is possible to accurately grasp that the number of fake sites in operation is 0, the number of fake sites in take-down is 1, and the number of fake sites taken down is 30 from the outline information displayed in the outline region 151. According to the example of FIG. 10, it is possible to intuitively grasp the transition of the operating status such as in-operation, in-take-down, and in-taken-down statues with respect to the plurality of detected fake sites.

In the example of FIG. 10, detailed information including a detection date, a status, a domain, a domain registrant, and an IP location of a fake site is displayed in the detail region 152. In the example of FIG. 10, the detailed information is displayed in descending order of the detection date of a fake site. According to the example of FIG. 10, the detection date, status, domain, domain registrant, and IP location of a fake site can be accurately grasped from the detailed information displayed in the detail region 152. For example, by checking the detection date and the status of a fake site together, it is possible to grasp the delay situation of the take-down of the fake site. For example, if the domain or the domain registrant and the IP location are checked together, it is easy to select an external agency to which the take-down is entrusted.

The detailed information displayed in the detail region 152 may be selectable according to the status. For example, it may display a check box for selecting each status of in-operation, in-take-down, and in-taken-down, and display detailed information of the status selected in the check box. The detail region 152 may sort detailed information of fake sites detected in a specific period. For example, the detail region 152 displays detailed information regarding the latest about 10 fake sites. The detail region 152 may be set such that the number of fake sites to be displayed can be designated.

The detail region 152 may be set such that detailed information of fake sites is sorted by IP location (country). If a plurality of fake sites are established in a particular country, contractors in that country can be asked to take countermeasures against the establishment of the fake sites that frequently occur in that country. In such a case, the contractor in that country can be asked to take countermeasures to prevent the establishment of a fake site that may occur in the future.

According to the example of FIG. 10, the outline information displayed in the outline region 151 and the detailed information displayed in the detail region 152 can be referred to in combination. For example, it is possible to grasp which domain's fake site is in the middle of being taken down by confirming that the number of fake sites in take-down displayed in the outline region 151 is one and referring to the domain whose status displayed in the outline region 151 is in the middle of processing. If the IP location of the fake site that is in take-down can be determined, the external agency to which the IP location is entrusted can be specified. For example, according to the number of elapsed days from the detection date, it is possible to determine whether to contact an entrusted external agency with the progress status of the take-down.

FIG. 11 is a conceptual diagram illustrating an example of the display information displayed on the screen of the management terminal. In the example of FIG. 11, in addition to the detection information of the fake site and the status of the take-down, a screen dump in which an image displayed on the fake site is captured is displayed in the detail region 152 of the screen of the management terminal 15. In FIG. 11, information other than the detection date, status, domain, and site image of a fake site is omitted. In FIG. 11, an outline of the operating status of the fake site is omitted. If the screen dump of the fake site can be referred to, the fake site can be easily retrieved on the Internet. If the fake site can be accessed, the operator of the fake site can be directly requested to close the fake site. By publicizing a screen dump of a fake site, it is possible to encourage a user of the Internet not to access the fake site. For example, the screen dump image may be enlarged and displayed by clicking the region of the screen dump of the fake site. With such a configuration, it is easy to confirm the details of the falsified content.

The display examples of FIGS. 10 and 11 are merely examples, and do not limit the display information displayed by the detection system of the present example embodiment. The positional relationship and arrangement of the information such as the detection information and the status can be arbitrarily set as long as the information is displayed in a dashboard format. The display format of the information such as the detection information and the status may be changed according to the status of the take-down. For example, the information such as the detection information and the status may be displayed in different colors, sizes, or fonts according to the status or urgency of the take-down. For example, the information such as the detection information and the status may be displayed in different colors and sizes according to the status of the take-down.

### (Operation)

Next, an operation of the detection system 10 of the present example embodiment will be described with reference to the drawings. Hereinafter, the detection device 11 and the control device 13 included in the detection system 10 will be individually described.

### [Detection Device]

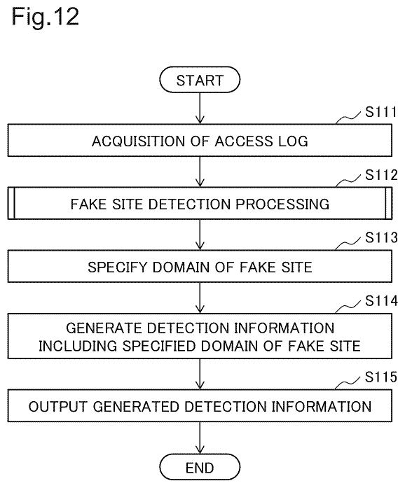

FIG. 12 is a flowchart for explaining an example of the operation of the detection device according to the present disclosure. In the description of the processing along the flowchart of FIG. 12, the components of the detection device 11 will be described as the operation subject. The operation subject of the processing along the flowchart of FIG. 12 may be the detection device 11.

In FIG. 12, first, the access log acquisition unit 111 obtains an access log from the access log database 17 (step S111). For example, the access log acquisition unit 111 acquires an access log at a preset timing. The access log acquisition unit 111 may acquire the access log at a timing when the access log is recorded in the access log database 17.

Next, the detection unit 113 executes a fake site detection processing (step S112). In the fake site detection processing, the detection unit 113 detects a fake site using an access log. A detailed example of the fake site detection processing in step S112 will be described later.

Next, the detection unit 113 specifies the domain of the detected fake site (step S113). For example, the detection unit 113 specifies a detection date of a fake site and a domain registrant or an IP location of the specified domain.

Next, the detection information generation unit 115 generates detection information including the specified domain of the fake site (step S114). For example, the detection information includes a detection date of a fake site, a domain registrant of a specified domain, and an IP location.

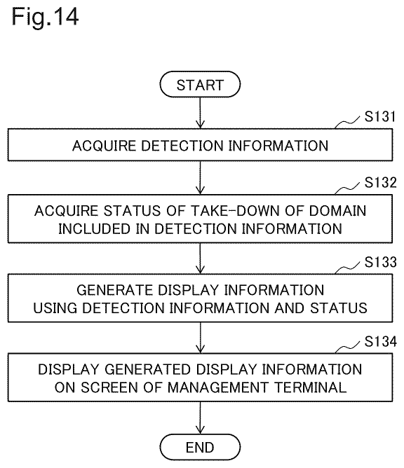

Next, the output unit 117 outputs the generated detection information to the control device 13 (step S115). The detection information output to the control device 13 is used to generate display information for grasping information regarding the fake site. After step S115, the process proceeds to the process in step S131 in FIG. 14.

### <Fake Site Detection Processing>

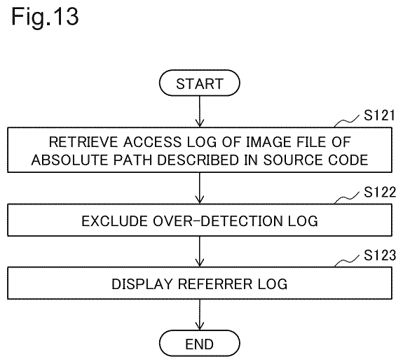

FIG. 13 is a flowchart for explaining an example of the fake site detection processing (step S112 in FIG. 12) according to the present disclosure. In the description of the processing along the flowchart of FIG. 13, the components of the detection device 11 will be described as the operation subject. The operation subject of the processing along the flowchart of FIG. 13 may be the detection device 11. The flowchart of FIG. 13 is an example of the fake site detection processing and does not limit the fake site detection processing.

In FIG. 13, first, the detection unit 113 retrieves an access log to an absolute path of an image file described in a source code of a site image of a management target site (step S121).

Next, the detection unit 113 excludes a domain registered in the whitelist from the retrieved access log as an over-detection log (step S122).

Next, the detection unit 113 detects a referrer log that refers to a site image of a management target site from the access log from which the over-detection log has been excluded (step S123). The domain at the reference source of the detected referrer log is relevant to the domain of the fake site. After step S123, the process proceeds to the augmentation processing in step S113 in FIG. 12.

### [Control Device]

FIG. 14 is a flowchart for explaining an example of the operation of the control device according to the present disclosure. In the description of the processing along the flowchart of FIG. 14, the components of the control device 13 will be described as the operation subject. The operation subject of the processing along the flowchart of FIG. 14 may be the control device 13.

In FIG. 14, first, the detection information acquisition unit 131 acquires detection information from the detection device 11 (step S131).

Next, the status acquisition unit 132 acquires the status of the take-down of the domain included in the detection information (step S132). For example, in a stage where a fake site has just been detected and take-down has not been entrusted to an external agency, the status is set to unprocessed.

Next, the display information generation unit 135 generates display information including information regarding a fake site by using the detection information and the status (step S133). For example, the display information includes outline information and detailed information regarding the fake site. The display information generation unit 135 generates display information indicating the operating status regarding the fake site in a dashboard format that can be easily grasped by the administrator.

Next, the display control unit 137 displays the generated display information on the screen of the management terminal 15 (step S134). On the screen of the management terminal 15, the operating status regarding the fake site is displayed in a display format that can be easily grasped by the administrator. The control device 13 may output the generated display information to an external system.

As described above, the detection system of the present example embodiment includes the detection device and the control device. The detection device includes an access log acquisition unit, a list storage unit, a detection unit, a detection information generation unit, and an output unit. The access log acquisition unit acquires an access log for a site information database in which an image described by an absolute path is stored in a management target site. The list storage unit stores a whitelist in which domains permitted to access the site information database are listed. The detection unit detects a domain that has accessed the site information database. The detection information generation unit generates detection information including information regarding the domain detected from the access log. The output unit outputs the generated detection information to the control device. The control device is provided with a detection information acquisition unit, a status acquisition unit, a storage unit, a display information generation unit, and a display control unit. The detection information acquisition unit acquires detection information of a fake site detected in response to access to a source code of an image described by an absolute path in a management target site. The status acquisition unit acquires a status regarding take-down of a fake site established in a domain included in detection information of the fake site. The storage unit stores a template of display information to be presented to the administrator. The display information generation unit generates display information including first information regarding each of at least one fake site falsified as a management target site and second information in which a status regarding take-down of each of at least one fake site is aggregated. The display control unit performs control to display the generated display information on the screen.

The control device according to the present example embodiment detects a fake site according to access to a source code of an image described by an absolute path. Therefore, according to the present example embodiment, it is possible to detect a fake site before full operation. The control device of the present example embodiment displays detection information of the detected fake site and a status regarding take-down of the fake site in a dashboard format. Therefore, according to the present example embodiment, it is possible to present information regarding a fake site in a state where it is easy to visually grasp. That is, according to the present example embodiment, it is possible to accurately grasp information regarding a fake site before the fake site is fully operated.

In an aspect of the present example embodiment, the display information generation unit generates display information including the operating status of the fake site based on the status regarding take-down of the fake site and the detection information of the fake site. The display control unit displays the display information including the operating status of the fake site on the screen of the management terminal. According to the present aspect, the information displayed on the screen can be accurately grasped for each fake site.

In an aspect of the present example embodiment, the display information generation unit generates display information including the number of fake sites that are in operation, the number of fake sites that are in take-down, and the number of fake sites that have been taken down as the operating status of the fake sites. The display control unit displays, on the screen, display information including the number of fake sites that are in operation, the number of fake sites that are in take-down, and the number of fake sites that have been taken down. According to the present aspect, the number of fake sites that are in operation, the number of fake sites that are in take-down, and the number of fake sites that have been taken down can be accurately grasped from the information displayed on the screen of the management terminal.

In an aspect of the present example embodiment, the display information generation unit generates display information including at least one of a detection date, a status, a domain, a domain registrant, or an IP location regarding a fake site as an operating status of the fake site. The display control unit displays, on a screen, display information including at least one of a detection date, a status, a domain, a domain registrant, or an IP location regarding a fake site. According to the present aspect, the detection date, the status, the domain, the domain registrant, and the IP location of the fake site can be accurately grasped from the information displayed on the screen.

In an aspect of the present example embodiment, the display information generation unit generates display information including a screen dump in which an image displayed on a fake site is captured as an operating status of the fake site. The display control unit displays display information including an image of a fake site on a screen. If the screen dump of the fake site can be referred to, the fake site can be easily retrieved on the Internet. If the fake site can be accessed, the operator of the fake site can be directly requested to close the fake site. By publicizing a screen dump of a fake site, it is possible to encourage a user of the Internet not to access the fake site.

A control device according to an aspect of the present example embodiment includes a detection information acquisition unit and a status acquisition unit. The detection information acquisition unit acquires detection information of a fake site detected in response to access to a source code of an image described by an absolute path in a management target site. The status acquisition unit acquires a status regarding take-down of a fake site established in a domain included in detection information of the fake site. This aspect is to clarify acquisition of detection information and a status.

In an aspect of the present example embodiment, the detection device compares a domain registered in a whitelist in which domains permitted to access the site information database are listed with a domain detected from an access log. In a case where the domain registered in the whitelist does not match the domain detected from the access log, the detection device determines that the domain detected from the access log is the domain of the fake site. According to the present aspect, a domain not registered in the whitelist can be detected as a domain of a fake site with reference to the whitelist.

### Second Example Embodiment

Next, a control device according to a second example embodiment will be described with reference to the drawings. The control device of the present example embodiment has a configuration in which the control device included in the detection system of the first example embodiment is simplified. The control device of the present example embodiment generates display information by using detection information output from the detection device included in the detection system of the first example embodiment.

### (Configuration)

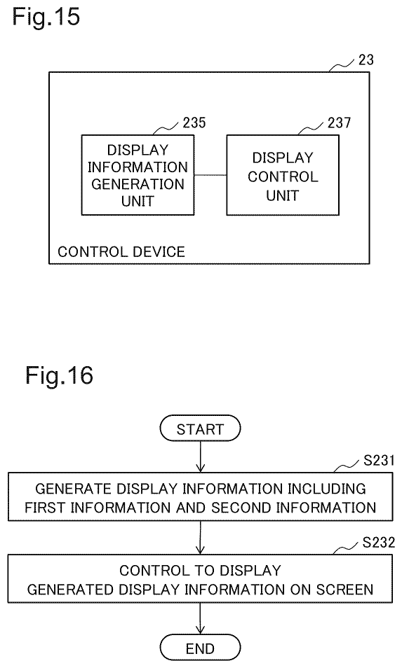

FIG. 15 is a block diagram illustrating an example of a configuration of a control device according to the present disclosure. A control device 23 includes a display information generation unit 235 and a display control unit 237.

The display information generation unit 235 generates display information including first information regarding each of at least one fake site falsified as a management target site and second information in which a status regarding take-down of each of at least one fake site is aggregated. The display control unit 237 performs control to display the generated display information on the screen.

### (Operation)

FIG. 16 is a flowchart for explaining an example of the operation of the control device according to the present disclosure. In the description of the processing along the flowchart of FIG. 16, the components of the control device 23 will be described as the operation subject. The operation subject of the processing along the flowchart of FIG. 16 may be the control device 23.

In FIG. 16, first, the display information generation unit 235 generates the display information including the first information and the second information (step S231). The first information is information regarding each of at least one fake site that falsifies the management target site. The second information is information in which the status regarding the take-down of each of the at least one fake site is aggregated.

Next, the display control unit 237 performs control to display the generated display information on the screen (step S232).

The display information generation unit 235 can be achieved by using, for example, a function of the display information generation unit 135 in FIG. 8. The display control unit 237 can be achieved, for example, by using a function of the display control unit 137 in FIG. 8.

As described above, the control device of the present example embodiment causes the display information including the first information regarding each of the at least one fake site falsified to be the management target site and the second information in which the status regarding the take-down of each of the at least one fake site is aggregated to be displayed on the screen. Therefore, according to the present example embodiment, it is possible to grasp computer security of a fake site or the like.

### (Hardware)

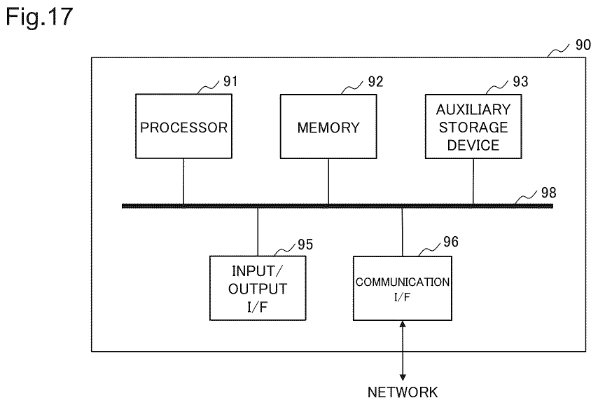

Next, a hardware configuration for executing control and processing in the present disclosure will be described with reference to the drawings. Here, an example of such a hardware configuration is an information processing device 90 (computer) in FIG. 17. The information processing device 90 in FIG. 17 is a configuration example for executing the control and processing in the present disclosure, and does not limit the scope of the present disclosure.

As illustrated in FIG. 17, the information processing device 90 includes a processor 91, a memory 92, an auxiliary storage device 93, an input/output interface 95, and a communication interface 96. In FIG. 17, the interface is abbreviated as an I/F. The processor 91, the memory 92, the auxiliary storage device 93, the input/output interface 95, and the communication interface 96 are data-communicably connected to each other via a bus 98. The processor 91, the memory 92, the auxiliary storage device 93, and the input/output interface 95 are connected to a network such as the Internet or an intranet via communication interface 96.

The processor 91 develops a program (instruction) stored in the auxiliary storage device 93 or the like in the memory 92. For example, the program is a software program for executing the control and processing in the present disclosure. The processor 91 executes the program developed in the memory 92. The processor 91 executes the control and processing in the present disclosure by executing the program.

The memory 92 is a storage device in which a program is developed. A program stored in the auxiliary storage device 93 or the like is developed in the memory 92 by the processor 91. The memory 92 is implemented by, for example, a volatile memory such as a dynamic random access memory (DRAM). A nonvolatile memory such as a magnetoresistive random access memory (MRAM) may be applied as the memory 92.

The auxiliary storage device 93 stores various data such as programs. For example, the auxiliary storage device 93 is implemented by a local disk such as a hard disk or a flash memory. Various data may be stored in the memory 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing in the present disclosure. The hardware configuration of FIG. 17 is an example of a hardware configuration for executing the control and processing in the present disclosure, and does not limit the scope of the present disclosure. A program for causing a computer to execute the control and processing in the present disclosure is also included in the scope of the present disclosure.

A program recording medium in which the program in the present example embodiment is also recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium.

The components in the present disclosure may be arbitrarily combined. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above example embodiments may be described as the following Supplementary Notes, but are not limited to the following.

### (Supplementary Note 1)

A control device including:
a display information generation unit that generates display information including first information regarding each of at least one fake site that falsifies a management target site and second information in which a status regarding take-down of each of the at least one fake site is aggregated; and
a display control unit that performs control to display the generated display information on a screen.

### (Supplementary Note 2)

The control device according to Supplementary Note 1, in which
the display information generation unit
generates the display information including an operating status of the fake site based on the status regarding take-down of the fake site and detection information of the fake site, and
the display control unit
displays the display information including the operating status of the fake site on the screen.

### (Supplementary Note 3)

The control device according to Supplementary Note 2, in which
the display information generation unit
generates the display information including a number of fake sites that are in operation, a number of fake sites that are in take-down, and a number of fake sites that have been taken down as the operating status of the fake sites, and
the display control unit
displays, on the screen, the display information including the number of fake sites that are in operation, the number of fake sites that are in take-down, and the number of fake sites that have been taken down.

### (Supplementary Note 4)

The control device according to Supplementary Note 2, in which
the display information generation unit
generates the display information including at least one of a detection date, a status, a domain, a domain registrant, or an Internet Protocol (IP) location regarding the fake site as the operating status of the fake site, and
the display control unit
displays, on the screen, the display information including at least one of the detection date, the status, the domain, the domain registrant, or the IP location regarding the fake site.

### (Supplementary Note 5)

The control device according to Supplementary Note 4, in which
the display information generation unit
generates the display information including a screen dump in which an image displayed on the fake site is captured as the operating status of the fake site, and
the display control unit
displays the display information including the screen dump on the screen.

### (Supplementary Note 6)

The control device according to Supplementary Note 1, including:
a detection information acquisition unit that acquires detection information of the fake site detected in response to access to a source code of an image described by an absolute path in the management target site; and
a status acquisition unit that acquires the status regarding take-down of the fake site established in a domain included in detection information of the fake site.

### (Supplementary Note 7)

The control device according to Supplementary Note 1, in which
a domain of the fake site is
a domain in which a domain registered in a whitelist having listed domains permitted to access a site information database storing an image described by an absolute path in a management target site does not match a domain detected from an access log for the site information database.

### (Supplementary Note 8)

A detection system including:
the control device according to any one of Supplementary Notes 1 to 7; and
a detection device that detects a domain that has accessed a site information database from an access log for the site information database in which an image described by an absolute path is stored in a management target site, generates detection information including information regarding a domain detected from the access log, and outputs the generated detection information to the control device.

### (Supplementary Note 9)

A control method causing a computer to execute:
generating display information including first information regarding each of at least one fake site that falsifies a management target site and second information in which a status regarding take-down of each of the at least one fake site is aggregated; and
performing control to display the generated display information on a screen.

### (Supplementary Note 10)

A program causing a computer to execute:
generating display information including first information regarding each of at least one fake site that falsifies a management target site and second information in which a status regarding take-down of each of the at least one fake site is aggregated; and
performing control to display the generated display information on a screen.

Some or all of the configurations described in Supplementary Notes 2 to 8 dependent on Supplementary Note 1 described above can also depend on Supplementary Notes 9 and 10 in the same dependency relationship as the Supplementary Notes 2 to 8. Not only Supplementary Notes 1, 9, and 10 but also various pieces of hardware, software, and various recording medium for recording software, or a system can be similarly dependent on some or all of the configurations described as Supplementary Notes without departing from the above-described example embodiments.

1. A control device comprising:
a secure storage;
a memory storing instructions; and
a processor connected to the memory and configured to execute the instructions to:
generate display information including first information regarding each of at least one fake site that falsifies a management target site and second information in which a status regarding take-down of each of the at least one fake site is aggregated; and
perform control to display the generated display information on a screen.

2. The control device according to claim 1, wherein
the processor is configured to execute the instructions to
generate the display information including an operating status of the fake site based on the status regarding take-down of the fake site and detection information of the fake site, and
display the display information including the operating status of the fake site on the screen.

3. The control device according to claim 2, wherein
the processor is configured to execute the instructions to
generate the display information including a number of fake sites that are in operation, a number of fake sites that are in take-down, and a number of fake sites that have been taken down as the operating status of the fake sites, and
display, on the screen, the display information including the number of fake sites that are in operation, the number of fake sites that are in take-down, and the number of fake sites that have been taken down.

4. The control device according to claim 2, wherein
the processor is configured to execute the instructions to
generate the display information including at least one of a detection date, a status, a domain, a domain registrant, or an Internet Protocol (IP) location regarding the fake site as the operating status of the fake site, and
display, on the screen, the display information including at least one of the detection date, the status, the domain, the domain registrant, or the IP location regarding the fake site.

5. The control device according to claim 4, wherein
the processor is configured to execute the instructions to
generate the display information including a screen dump in which an image displayed on the fake site is captured as the operating status of the fake site, and
display the display information including the screen dump on the screen.

6. The control device according to claim 1, wherein
the processor is configured to execute the instructions to
acquire detection information of the fake site detected in response to access to a source code of an image described by an absolute path in the management target site; and
acquire the status regarding take-down of the fake site established in a domain included in detection information of the fake site.

7. The control device according to claim 1, wherein
a domain of the fake site is a domain in which a domain registered in a whitelist having listed domains permitted to access a site information database storing an image described by an absolute path in a management target site does not match a domain detected from an access log for the site information database.

8. A detection system comprising:
the control device according to claim 1; and
a detection device that comprises
a memory storing instructions; and
a processor connected to the memory and configured to execute the instructions to
detect a domain that has accessed a site information database from an access log for the site information database in which an image described by an absolute path is stored in a management target site,
generate detection information including information regarding a domain detected from the access log, and
output the generated detection information to the control device.

9. A control method causing a computer to execute:
generating display information including first information regarding each of at least one fake site that falsifies a management target site and second information in which a status regarding take-down of each of the at least one fake site is aggregated; and
performing control to display the generated display information on a screen.

10. A non-transitory recording medium having stored therein a program causing a computer to execute:
generating display information including first information regarding each of at least one fake site that falsifies a management target site and second information in which a status regarding take-down of each of the at least one fake site is aggregated; and
performing control to display the generated display information on a screen.
